(19) United States
(12) Patent Application Publication
(10) Pub. No.: US 2020/0353575 A1
(43) Pub. Date: Nov. 12, 2020

(54) Welding Accessory Tool for Thin Walled Pipes

(71) Applicant: William Todd Aycock, Vancleave, MS (US)

(72) Inventor: William Todd Aycock, Vancleave, MS (US)

(21) Appl. No.: 16/828,724

(22) Filed: Mar. 24, 2020

Related U.S. Application Data
(60) Provisional application No. 62/845,168, filed on May 8, 2019.

(51) Int. Cl. B23K 37/053

(52) U.S. Cl. CPC B23K 37/0531

(57) ABSTRACT

A welding accessory tool for thin walled pipes includes a bolt, a first hub, a second hub, and a plurality of arm assemblies. Each of the plurality of arm assemblies that is radially positioned around the first hub and second hub includes a first arm section, a flat arm section, and a second arm section. The first arm section is hingedly mounted to the flat arm section and the second arm section. The first arm section and the second arm section are terminally positioned opposite of each other about the flat arm section. The first arm section is hingedly mounted to the first hub. The second arm section is hingedly mounted to the second hub. The first hub is concentrically positioned around the bolt. The second hub is threadedly engaged with the bolt thus enabling the arm assemblies to expand and collapse through rotational movement of the bolt.

The current application claims a priority to the U.S. Provisional Patent application Ser. No. 62/845,168 filed on May 8, 2019.

### FIELD OF THE INVENTION

The present invention is related to a welding accessory tool. More specifically, the present invention is an apparatus that expands and collapses to hold a thin-walled pipe in place for welding. The present invention also makes out of round thin-walled pipes into a precisely circular profile for welding.

### BACKGROUND OF THE INVENTION

In modern day society, there are many large and magnificent steel structures. This is possible because of the basic component of the framework. This framework contains smaller pieces that are assembled together to form larger pieces. But to attach these pieces together, a bond needs to be formed between them. Throughout history, steel has been the element of choice for building. To hold the steel together, the process of welding has been developed. The welding process has been very important throughout the manufacturing and construction industry. From steel skyscrapers to aircraft carriers, to intricate piping complexes, most of the structure has to be welded together. Welding is effective because it provides a strong bond between the metals. During the processes of welding, the two attachment points are melted with a very hot torch. A filler material is added and the metal cools, forming a very strong bond.

In the marine industry there are many parts that need to be welded together. More specifically, there are many thin-walled pipes that need to be joined together end to end by welding. The skilled workers who weld these pipes are aware of many problems and nuisances when working with pipefitting. More often than not, the pipes that are required to be welded together are not perfectly round. This is because during shipping, improper storage, and handling, the circularity of the pipes becomes warped. This presents many problems because trying to weld two disfigured circular objects together can be very difficult. Besides the difficulties of welding misaligned parts together, just holding the pipes in close proximity is a challenge in itself. There are currently no tools that provide the proper alignment of fittings to the pipe while reestablishing the proper roundness of the pipe. The roundness of the pipe must exactly match that of the fitting. It is very hard for one person to align the pipes. Currently the only methods for aiding in pipe welding are backing rings and chain clamps. But often time the job environment and the condition of the rings prohibit the use of these rings. Without these rings the completion time of the project increases by four times.

The present invention provides a solution to these problems. The present invention reshapes the pipe ends that have been flattened or non-circular, into a circular shape. It also temporarily mates the thin walled pipes to the object it is being welded to. As well as straight pipes, the present invention can mate pipes containing a 45- or 90-degree elbow. Once the pipes are aligned and held in place by the present invention, the welder can easily weld the pipes together. The present invention makes this process much simpler for the welder.

### BRIEF DESCRIPTION OF THE DRAWINGS

FIG. 1 is a perspective view of the present invention shown in the expanded configuration.

FIG. 2 is a side view of the present invention shown in the expanded configuration.

FIG. 3 is a rear view of the present invention shown in the expanded configuration.

FIG. 4 is a side view of the present invention shown in the expanded configuration, wherein only one of the plurality of arm assemblies in shown to illustrate the first and second acute angles.

FIG. 5 is a side view of the bolt of the present invention.

FIG. 6 is a perspective view of the spacer of the present invention.

FIG. 7 is a perspective view of the first hub of the present invention.

FIG. 8 is a perspective view of the second hub of the present invention.

FIG. 9 is a perspective view of the present invention shown in the collapsed configuration.

### DETAIL DESCRIPTIONS OF THE INVENTION

All illustrations of the drawings are for the purpose of describing selected versions of the present invention and are not intended to limit the scope of the present invention.

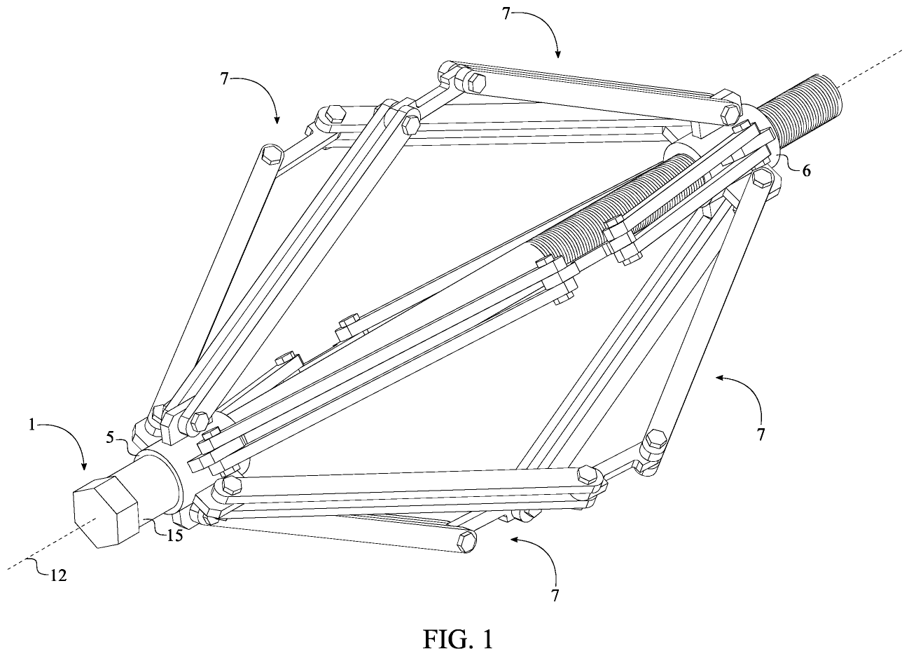

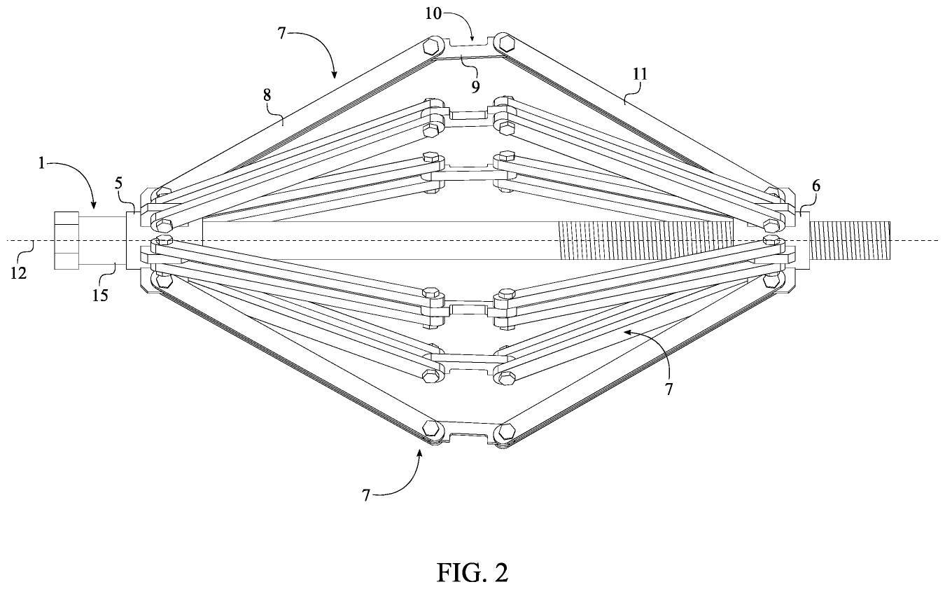

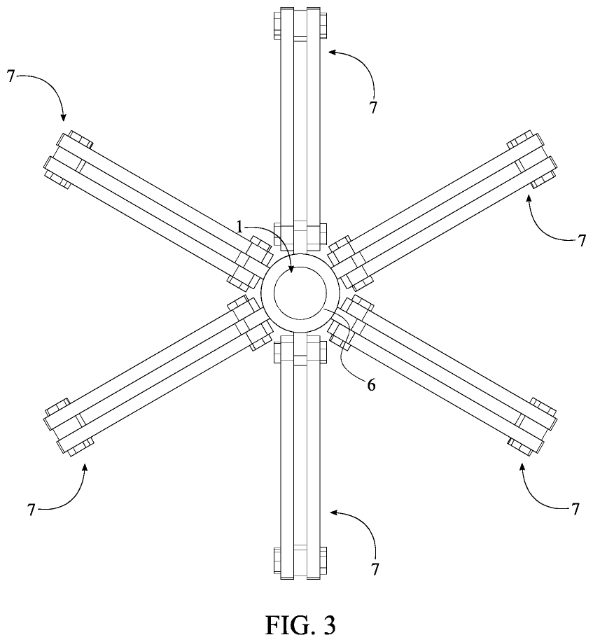

The present invention is an apparatus that expands and collapses to hold thin-walled pipe in place for welding. The present invention is also able to adjust any non-circular or deformed pipes into an exact circular shape thus simplifying the welding of two pipes together. The configuration of the present invention also enables welding of straight pipes, 45 degree elbow pipes, and 90 degree elbow pipes so that the user of the present invention do not have to carry multiple welding accessory tools to weld pipes together. The present invention comprises a bolt 1, a first hub 5, a second hub 6, and a plurality of arm assemblies 7 as shown in FIG. 1-3. Each of the plurality of arm assemblies 7 that radially presses against an inner wall of a pipe comprises a first arm section 8, a flat arm section 9, a notch 10, and a second arm section 11 as shown in FIG. 2.

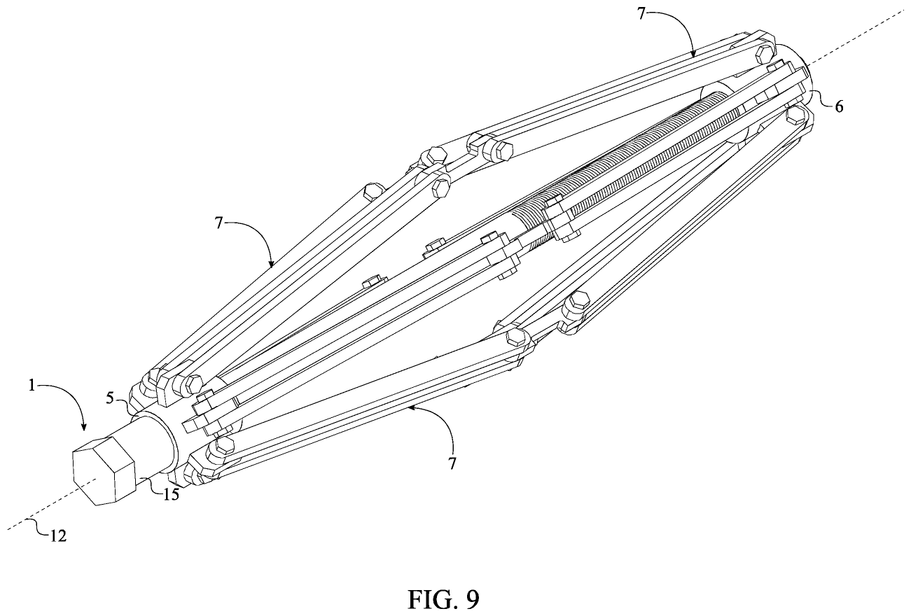

In reference to the general configuration of the present invention, each of the plurality of arm assemblies 7 is radially positioned around the first hub 5 and the second hub 6 so that the expanded configuration of the present invention is able to press against the inner wall of two adjacently positioned pipes thus securing a subsequent pipe to a preceding pipe. Furthermore, each of the plurality of arm assemblies 7 uniformly expands about a central axis 12 that is concentrically positioned along the bolt 1 so that any non-circular or deformed shapes of the two adjacently positioned pipes can be reshaped into an exact circular shape. More specifically, the first arm section 8 is hingedly mounted to the flat arm section 9. The second arm section 11 is hingedly mounted to the flat arm section 9 as the first arm section 8 and the second arm section 11 are terminally positioned opposite of each other about the flat arm section 9. In other words, the flat arm section 9 is positioned and hingedly connected in between the first arm section 8 and the second arm section 11. The first arm section 8 is hingedly mounted to the first hub 5 and positioned opposite of the flat arm section 9. Resultantly, each of the plurality of arm assemblies 7 is able to mount to the first hub 5 through the hinged connection of the first arm section 8 and the first hub 5. The second arm section 11 is hingedly mounted to the second hub 6 and positioned opposite of the flat arm section 9. Resultantly, each of the plurality of arm assemblies 7 is able to mount to the second hub 6 through the hinged connection of the second arm section 11 and the second hub 6. The first hub 5 is concentrically positioned around the bolt 1, and the second hub 6 is threadedly engaged with the bolt 1. As a result, the rotational movement of the bolt 1 can be transferred into a linear motion of the second hub 6 thus enabling the second hub 6 to travel up and down along the bolt 1. For example, the upward movement of the second hub 6 transforms the present invention into the expanded configuration while the downward movement of the second hub 6 transforms the present invention into the collapsed configuration as shown in FIG. 1 and FIG. 9.

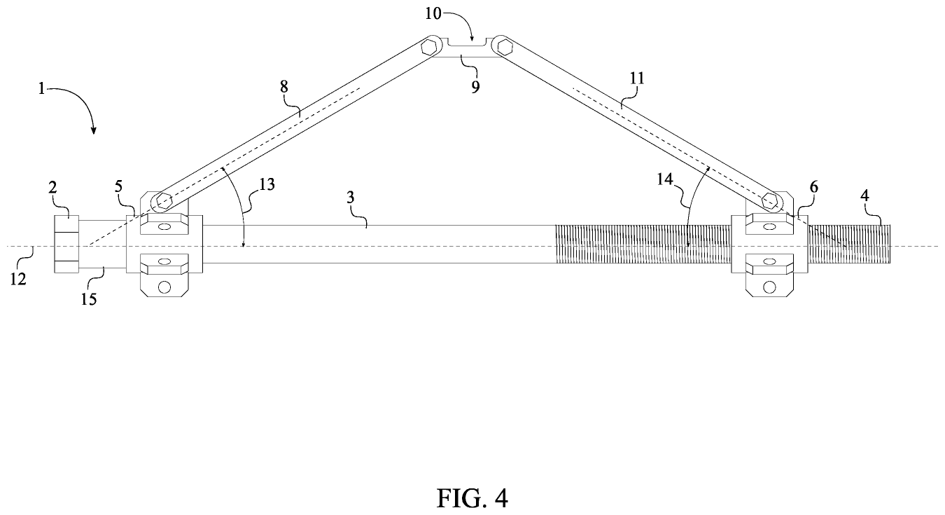

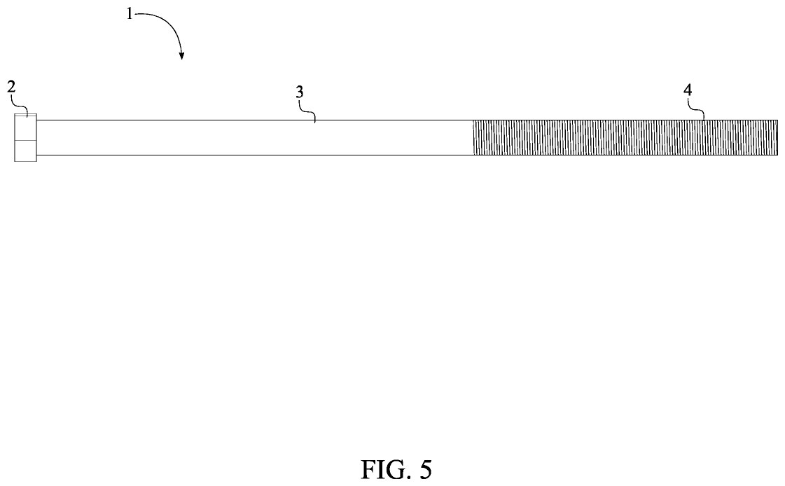

The bolt 1 comprises a head 2, a shank section 3, and a threaded section 4 as shown in FIG. 4-5. The head 2, the shank section 3, and the threaded section 4 being concentrically positioned with each other and linearly positioned along the central axis 12. The head 2 is preferably formed into a hexagonal shape so that the bolt 1 can be easily rotated with standard tools such as sockets and spanners. The head 2 and the threaded section 4 are oppositely positioned of each other about the shank section 3, wherein the shank section 3 is a cylindrical body. The head 2 is terminally connected to the shank section 3. The threaded section 4 is terminally connected to the shank section 3. The thread length of the threaded section 4 is determined upon the maximum radial expansion of the plurality of arm assemblies 7. For example, when the second hub 6 is positioned at a top end of the threaded section 4 that is positioned adjacent to the head 2, the present invention is able to gain the maximum radial expansion for the plurality of arm assemblies 7. Oppositely, when the second hub 6 is positioned at a bottom end of the threaded section 4, the present invention is able to gain the minimum radial expansion for the plurality of arm assemblies 7 as the bottom end and the head 2 are oppositely positioned of each other about the bolt 1. Preferably, the pitch of the threaded section 4 is shallow to allow the present invention to be expanded and collapsed easily, wherein a shallow pitch allows for more revolutions per linear distance unit.

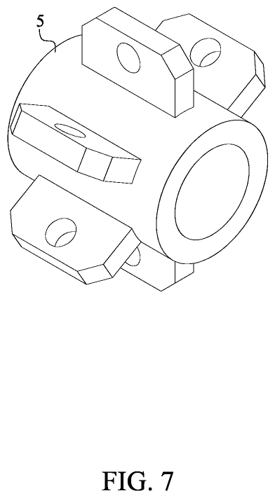

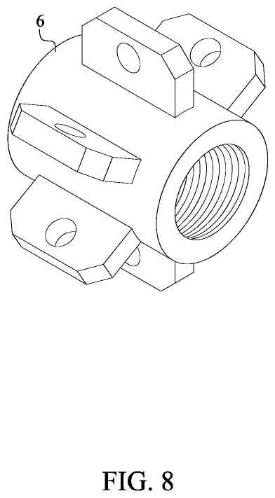

The first hub 5 is slidably positioned around the shank section 3 and positioned adjacent to the head 2 as shown in FIG. 1 and FIG. 7-8. The first hub 5 is a cylindrical sleeve body and functions as a slider that is free to move along the shank. Furthermore, the first hub 5 is able to stationary positioned with the present invention while the rotational force is applied to the bolt 1. The second hub 6 is a cylindrical sleeve body and threadedly engaged around the threaded section 4. In other words, the second hub 6 is able to move along the threaded section 4 while rotational force is applied to the bolt 1. For example, when the bolt 1 is turned in clockwise direction, the rotational movement of the threaded section 4 causes the second hub 6 to linearly move upward and toward the head 2 thus transforming the present invention into the expanded configuration. When the bolt 1 is turned in counterclockwise direction, the rotational movement of the threaded section 4 causes the second hub 6 to linearly move downward and away from the head 2 thus transforming the present invention into the collapsed configuration.

In reference to FIG. 4, the first arm section 8, the flat arm section 9, and the second arm section 11 are generally rectangular shape elongated bodies that can stretch from first hub 5 to the second hub 6. Furthermore, the first arm section 8, the flat arm section 9, and the second arm section 11 each comprises a first curved end and a second curved end. More specifically, an opening laterally traverses through the first curved end and the second curve end thus delineating an attachment point for the first arm section 8, the flat arm section 9, and the second arm section 11. The opening provides a void so that a male fastener that engages with a female fastener can be inserted through the opening. The male fastener and the female fastener collectively function as the fastening mechanism so that the first arm section 8, the flat arm section 9, and the second arm section 11 can be mounted to each other. Furthermore, washers can be placed around the male fastener to properly configure each of the fastening mechanism.

In reference to FIG. 4, a first acute angle 13 of the present invention is delineated about the first hub 5. More specifically, the first arm section 8 is laterally mounted to the first hub 5 thus delineating the first acute angle 13 in between the first arm section 8 and the central axis 12. The first acute angle 13 defines the maximum radial distance that the flat arm section 9 can extend with respect the first arm section 8.

In reference to FIG. 4, a second acute angle 14 of the present invention is delineated about the second hub 6. More specifically, the second arm section 11 is laterally mounted to the second hub 6 thus delineating the second acute 14 in between the second arm section 11 and the central axis 12. The second acute angle 14 defines the maximum radial distance that the flat arm section 9 can extend with respect the second arm section 11.

All the components of the present invention is preferably made of steel to withstand constant impact and force that may applied during the welding process of two pipes, except the flat arm section 9. Furthermore, rigid construction of the present invention enables the user to easily stretch the pipe into circular profile when the pipe is non-circular or deformed. The flat arm section 9 is preferably made of stainless steel to keep away cross contamination of the two adjacently positioned pipes. However, the present invention can be made of any other types of material other than steel and stainless steel as long as the structural and functional properties of the present invention can be attained.

In particular, the flat arm section 9 that encircles the inner wall of the pipes, at the area of the seam where welding would take place, could possibly be welded to the inner wall of the pipes, preventing the present invention from being removed after completion. The notch 10, as shown in FIG. 4, address the accidently welding of the flat arm section 9 to the inner wall of the pipes in which it would be used. The notch 10 traverses into the flat arm section 9 and oriented outward from the bolt 1. As a result, the notch 10 is able to provide space in between the seam where welding would take place thus preventing direct contact with the inner wall of the pipes so that the initial or root pass weld could inadvertently weld the flat arm section 9 to the inner wall of the pipes.

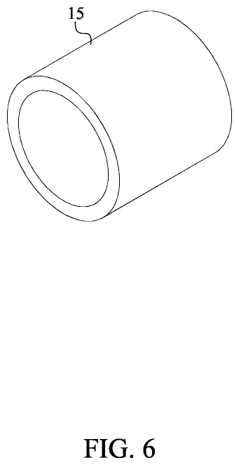

In reference to FIG. 1 and FIG. 6, the present invention further comprises a spacer 15. The spacer 15 is concentrically positioned around the shank section 3 and positioned in between the head 2 and the first hub 5. The spacer 15 provides gap between the first hub 5 and the head 2 so that a torque applying tool can be fully inserted around the head 2 without any interference from the plurality of arm assemblies 7.

In reference to a method of use, the present invention is placed within a thin walled pipe that requires welding. The center of the flat arm section 9, the notch 10, is aligned with the seam of the two adjacently positioned pipes to be connected. A torque applying tool is then engaged with the head 2. When the torque applying tool is turned, the bolt 1 simultaneously turns with the torque applying tool. This causes the threaded section 4 to turn which moves the second hub 6 up and down upon the rotational direction of the torque applying tool. By moving the second hub 6, the first acute angle 13 and the second acute angle 14 are changed. This causes the flat arm section 9 to move inward or outward about the central axis 12 upon the rotational direction of the torque applying tool. When the present invention is in the expanded configuration, the radial expansion of the plurality of arm assemblies 7 is determined upon the diameter of the pipes. When the flat arm section 9 of each of the arm assemblies 7 is moved outward, pressure is placed on the inner wall of the pipes. The pressure is distributed equally from each of plurality of arm assemblies 7 thus causing the pipes to mend into a precise circular profile and become concentric with each other. The pressure also holds the pipes into place for welding. After the welding is completed, the torque applying tool is used to turn the bolt 1 until the present invention is in collapsed configuration. The present invention can then be removed from the pipes for reuse.

Although the invention has been explained in relation to its preferred embodiment, it is to be understood that many other possible modifications and variations can be made without departing from the spirit and scope of the invention as hereinafter claimed.

What is claimed is:

1. A welding accessory tool for thin walled pipes comprising:
a bolt;
a first hub;
a second hub;
a plurality of arm assemblies;
each of the plurality of arm assemblies comprising a first arm section, a flat arm section, a notch, and a second arm section;
the first arm section being hingedly mounted to the flat arm section;
the second arm section being hingedly mounted to the flat arm section;
the first arm section and the second arm section being terminally positioned opposite of each other about the flat arm section;
the first arm section being hingedly mounted to the first hub, opposite of the flat arm section;
the second arm section being hingedly mounted to the second hub, opposite of the flat arm section;
the first hub being concentrically positioned around the bolt;
the second hub being threadedly engaged with the bolt; and
each of the plurality of arm assemblies being radially positioned around the first hub and the second hub.

2. The welding accessory tool for thin walled pipes as claimed in claim 1 comprising:
the bolt comprising a head, a shank section, and a threaded section;
the head, the shank section, and the threaded section being concentrically positioned with each other;
the head and the threaded section being oppositely positioned of each other about the shank section;
the head being terminally connected to the shank section; and
the threaded section being terminally connected to the shank section.

3. The welding accessory tool for thin walled pipes as claimed in claim 2 comprising:
the first hub being slidably positioned around the shank section; and
the second hub being threadedly engaged around the threaded section.

4. The welding accessory tool for thin walled pipes as claimed in claim 1 comprising:
a central axis; and
the central axis being concentrically positioned along the bolt.

5. The welding accessory tool for thin walled pipes as claimed in claim 4 comprising:
a first acute angle;
the first arm section being laterally mounted to the first hub; and
the first acute angle being positioned in between the first arm section and the central axis.

6. The welding accessory tool for thin walled pipes as claimed in claim 4 comprising:
a second acute angle;
the second arm section being laterally mounted to the second hub; and
the second acute angle being positioned in between the second arm section and the central axis.

7. The welding accessory tool for thin walled pipes as claimed in claim 1 comprising:
a spacer;
the spacer being concentrically positioned around a shank section of the bolt; and
the spacer being positioned in between a head of the bolt and the first hub.

8. The welding accessory tool for thin walled pipes as claimed in claim 1 comprising:
the notch traversing into the flat arm section; and
the notch being oriented outward from the bolt.
